(19) United States
(12) Patent Application Publication
(10) Pub. No.: US 2014/0054291 A1
(43) Pub. Date: Feb. 27, 2014

(54) Flexible Cover for Container

(71) Applicants: Andre Anton Lewis, Benicia, CA (US); Ryan Duke, Oakland, CA (US)

(72) Inventors: Andre Anton Lewis, Benicia, CA (US); Ryan Duke, Oakland, CA (US)

(73) Assignee: ABUTECH LLC, Memphis, TN (US)

(21) Appl. No.: 13/971,438

(22) Filed: Aug. 20, 2013

Related U.S. Application Data
(60) Provisional application No. 61/684,881, filed on Aug. 20, 2012.

(51) Int. Cl. B65D 43/02; B29C 45/14

(52) U.S. Cl. CPC B65D 43/0214; B29C 45/14819
USPC 220/378; 264/250

(57) ABSTRACT

In some aspects, the present concepts include a flexible cover for engaging and sealing an open-ended container, the flexible cover including a silicone rubber substrate and a plurality of slats disposed within the silicone rubber substrate, the plurality of slats being spaced apart from one another.

### REFERENCE TO RELATED APPLICATIONS

This application is related to and claims priority to U.S. provisional patent application Ser. No. 61/684,881, filed Aug. 20, 2012, and titled “FLEXIBLE COVER FOR CONTAINER,” which is incorporated herein by reference in its entirety.

### FIELD OF THE INVENTION

The present invention relates generally to covers for containers and, more particularly, to covers for food storage and for cookware containers.

### BACKGROUND OF THE INVENTION

Conventionally, food storage containers and cookware are provided with matingly engageable covers adapted to engage and seal, to varying degrees, the food storage container or cookware. Conventional arrangements include, for example, a cover and/or the base comprising one or more latching mechanisms, or a cover and base pair configured to provide, in combination, an interference or frictional connection. In the case of cookware, a cover is often configured with a circumferential shoulder dimensioned to nestle within a corresponding ledge or shoulder formed in the upper circumference of the cookware. Such seals provide great utility when the cover is placed so as to occlude and/or seal the opening in the food storage container or cookware, thereby protecting the contents of such food storage container or cookware from external contaminants and minimizing or preventing undesired leakage or spillage.

As one example, reclosable containers have long been known and typically comprise a container and a closure device or cover adapted to sealingly cooperate with the container, with the container having a sidewall and bottom collectively defining at least one open end portion or opening, with the cover having a generally peripheral shoulder portion formed to seat over, by frictional engagement or interference seal, the open end portion, such as is disclosed in U.S. Pat. No. 4,027,776.

Despite the plethora of existing food storage container and cookware designs, there remains a need to further improve upon the design and operation of conventional covers for food storage and for cookware containers.

### SUMMARY OF THE INVENTION

According to at least one aspect of the present invention, a flexible cover is provided for engaging and sealing an open-ended container, the flexible cover including a silicone rubber substrate and a plurality of slats disposed within the silicone rubber substrate, the plurality of slats being spaced apart from one another.

According to another aspect of the present concepts, a method of forming a flexible cover for engaging and sealing an open-ended container, the flexible cover comprising a silicone rubber substrate and a plurality of slats disposed within the silicone rubber substrate, the plurality of slats being spaced apart from one another, the method including the acts of injecting silicone rubber into a first mold to form a lower portion of the flexible cover, the first mold comprising a first upper mold part dimensioned to define lower surfaces of the flexible cover and a first lower mold part dimensioned to define intermediary surfaces of the flexible cover, the lower surfaces of the flexible cover comprising a substantially planar bottom surface and the intermediary surfaces comprising a plurality of defined openings dimensioned to receive a plurality of slats. The method also includes the act of removing the first upper mold part to provide access to the formed lower portion of the flexible cover, inserting a slat in each of the openings defined by the upper surface of the lower portion of the flexible cover, and disposing a second upper mold part over the first lower mold part to form a second mold, the second upper mold part dimensioned to define upper surfaces of the flexible cover. The method further includes the act of injecting silicone rubber into the second mold to form an upper portion of the flexible cover, the upper portion of the flexible cover being joined to the lower portion of the flexible cover so as to encapsulate the plurality of slats disposed therein.

According to yet another aspect of the present concepts, a flexible cover for engaging and sealing an open-ended container includes a silicone rubber substrate having a web region characterized by a first thickness and a first rigidity and a plurality of second regions characterized a second thickness and a second rigidity, wherein the second thickness of the plurality of second regions is greater than the first thickness of the web region.

The foregoing and additional aspects and implementations of the present disclosure will be apparent to those of ordinary skill in the art in view of the detailed description of various implementations and/or aspects, which is made with reference to the drawings, a brief description of which is provided next.

### BRIEF DESCRIPTION OF THE DRAWINGS

FIG. 1 illustrates a perspective top view of a flexible container cover according to a first embodiment of the present invention.

FIG. 2 illustrates a perspective bottom view of the flexible container cover of FIG. 1.

FIG. 3 is a top view of the flexible container cover of FIG. 1.

FIG. 4 is a first side view along a first axis of the flexible container cover of FIG. 3.

FIG. 5 is a second side view along a second axis of the flexible container cover of FIG. 3.

FIG. 6 is a bottom view of the flexible container cover of FIG. 1.

FIG. 7 is a first side view along a first axis of the flexible container cover of FIG. 7.

FIG. 8 is a second side view along a second axis of the flexible container cover of FIG. 7.

FIG. 9 is a cross-sectional view taken along line 9-9 in FIG. 3.

FIG. 10 is an enlarged view taken along line 10-10 of FIG. 5.

FIG. 11 is a cross-sectional view taken along line 9-9 in FIG. 3.

FIG. 12 is an enlarged view taken along line 12-12 of FIG. 4.

FIG. 13 shows a top view, perspective view, front view and side view, depicting dimensions of a flexible container cover according to one aspect of an embodiment of the present concepts.

FIG. 14 shows a top view, perspective view, and front view of a first flexible container cover slat according to one aspect of an embodiment of the present concepts.

FIG. 15 shows a top view, perspective view, and front view of a second flexible container cover slat according to one aspect of an embodiment of the present concepts.

FIG. 16 shows a top view, perspective view, and front view of a third flexible container cover slat according to one aspect of an embodiment of the present concepts.

FIG. 17 shows a top view, perspective view, and front view of a fourth flexible container cover slat according to one aspect of an embodiment of the present concepts.

FIG. 18 shows a top view, perspective view, and front view of a seventh flexible container cover slat according to one aspect of an embodiment of the present concepts.

FIG. 19 shows a top view, perspective view, and front view of a ninth flexible container cover slat according to one aspect of an embodiment of the present concepts.

FIG. 20 shows a top view of a slat according to one aspect of an embodiment of the present concepts and a sequence of acts used to form, from the slat, a flexible container cover according to an embodiment of the present concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

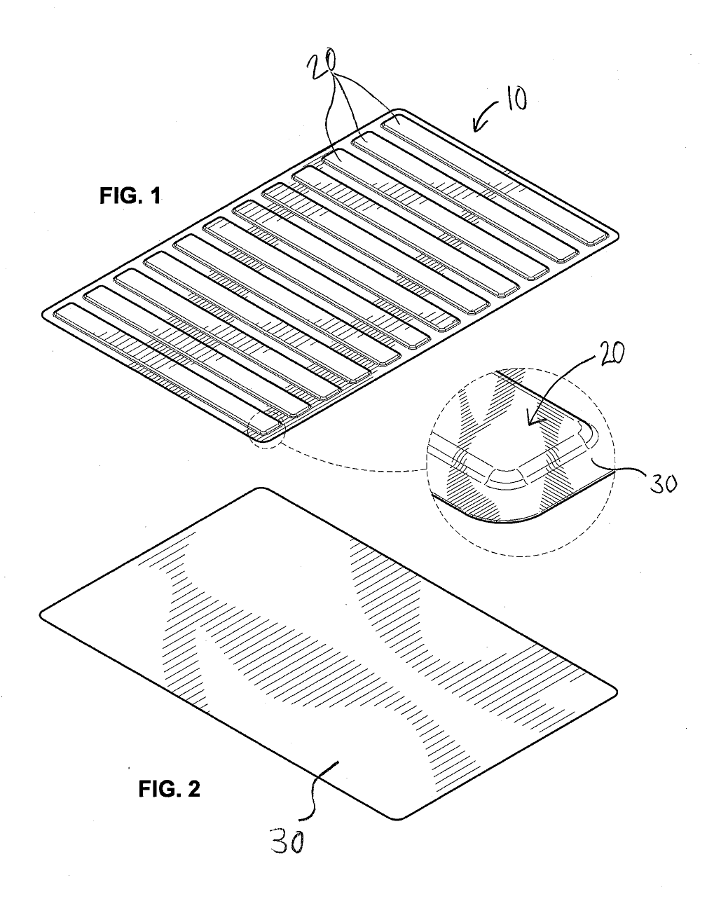

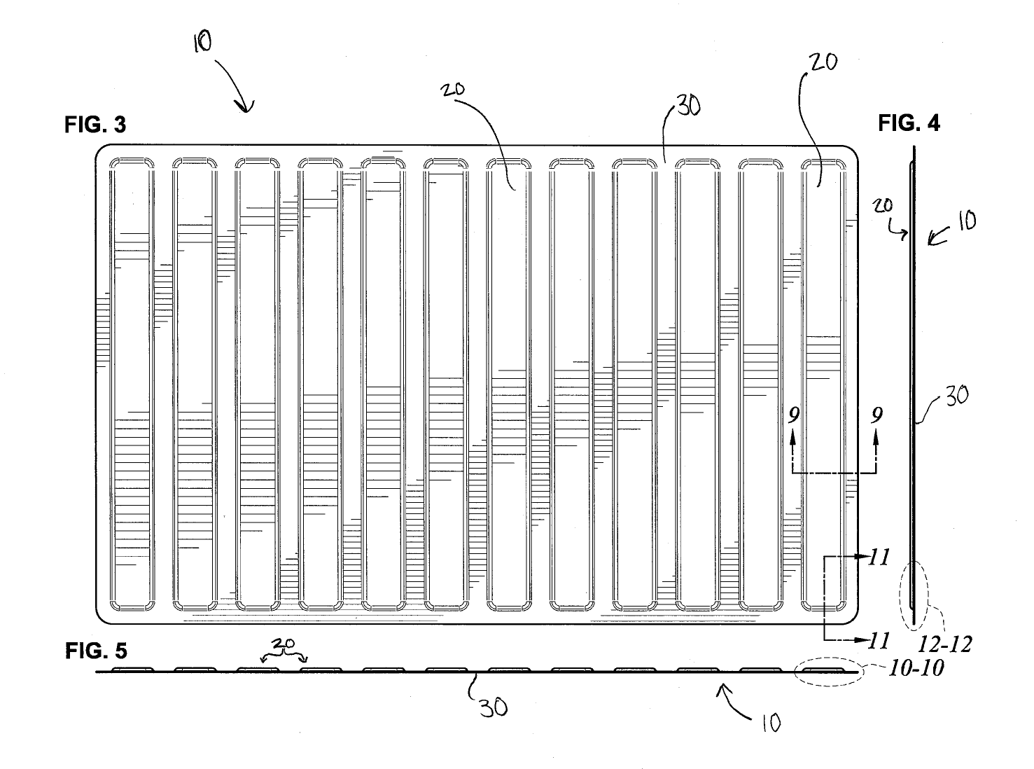

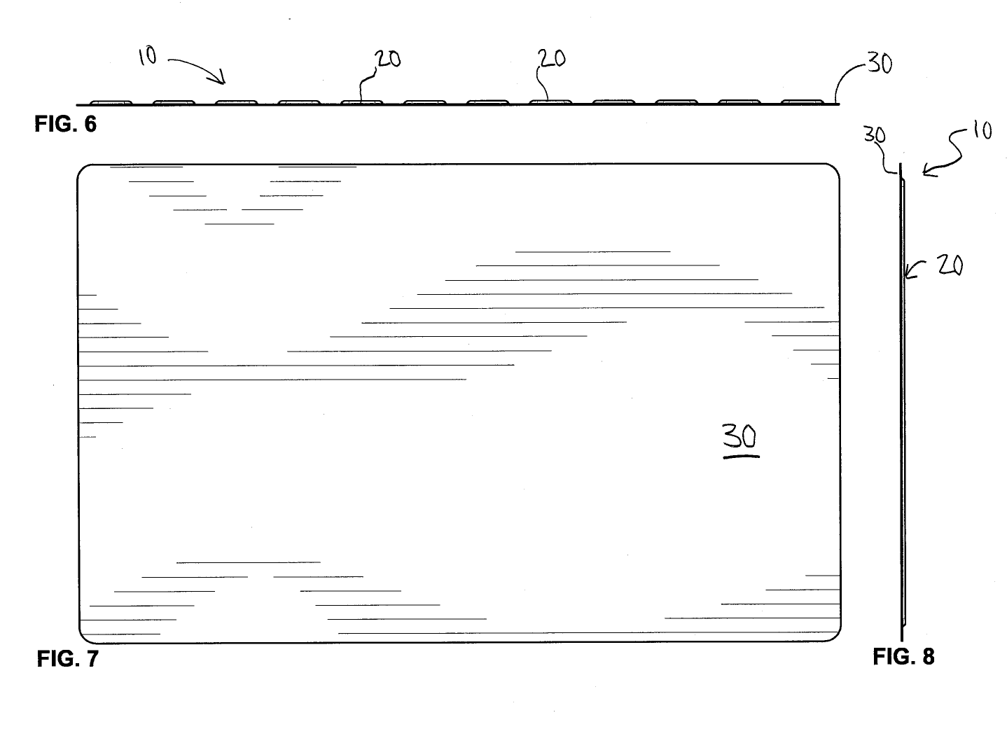

Referring to FIGS. 1-20, there are shown aspects of the present concepts relating to an improved, multi-use, flexible cover for food service containers, food storage containers, and food preparation containers. The flexible material forming the body of the flexible cover 10 comprises an elastomer such as, but not limited to, silicone rubber. By way of example, the elastomer may be selected from any FDA food safe elastomer or flexible material such as, but not limited to, those identified in 21 CFR §177.2600, titled “Rubber articles intended for repeated use”. Although certain aspects of the flexible cover are desired to permit multi-use flexibility (e.g., use at room temperature and use at elevated temperatures as silicone bakeware for cooking), other aspects of the present concepts contemplate use only in a single environment (e.g., only at room temperatures, but not for cooking) Thus, in at least some aspects, an elastomer is selected to providing a high heat resistance (e.g., up to about 500° F.) to thereby permit the flexible cover 10 to be safely used in a conventional oven, microwave, or toaster ovens. In yet other aspects, at a minimum, the material selected for the body of the flexible cover 10 is suitable for cleaning in a dishwasher.

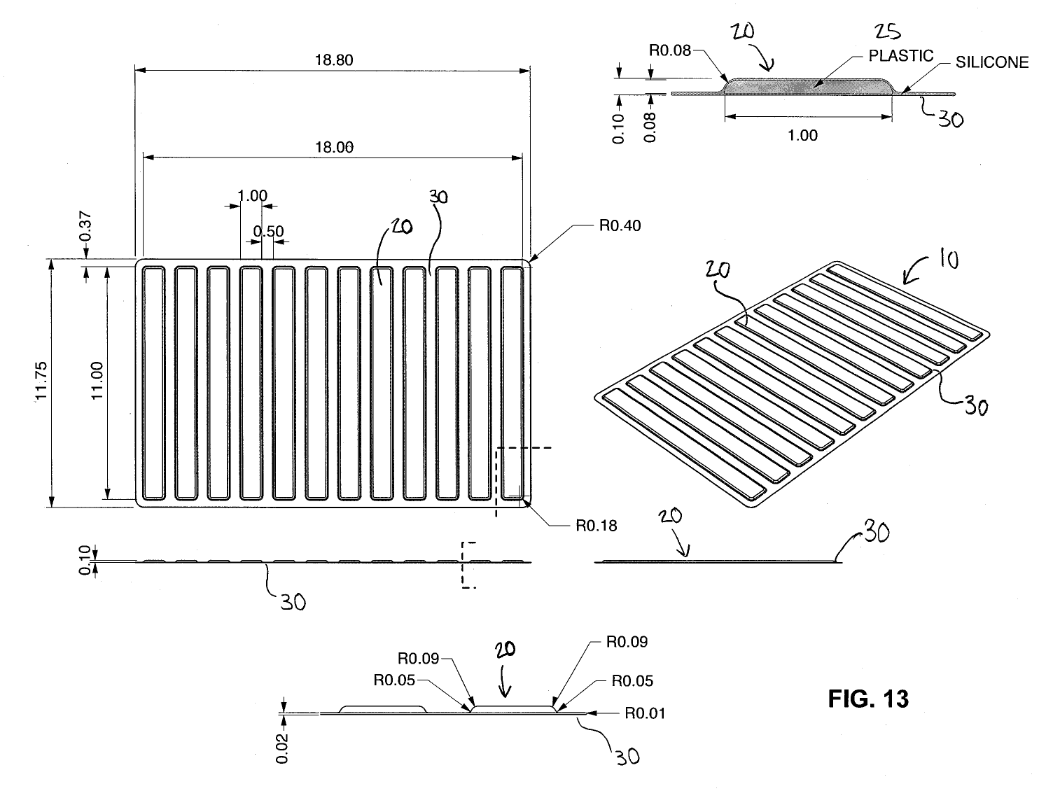

Dimensionally, the flexible cover 10 is advantageously, but not necessarily, configured for application to a wide variety of container or cookware sizes. By way of example, FIG. 13 shows a flexible cover 10 that is 18.8″ long and 11.75″ wide, which can fit over any rectangular opening up to about 18.75″×11.70″, any square opening up to about 11.70″×11.70″, or any round opening of up to about a diameter of about 11.70″. Of course, the dimensions of the flexible cover 10 are variable so as to adapt to different intended uses. For example, the flexible cover 10 may be rectangular, square, round, or oval, with dimensions selected to permit use with not just one desired coverage area, but a plurality of coverage areas.

The thickness of the elastomer forming the flexible cover 10 need not be uniform in thickness. In at least some aspects, the elastomer forming the flexible cover 10 has a thickness of about 0.02″ (0.5 mm). In at least some other aspects, the elastomer forming the flexible cover 10 has a thickness of about 0.04″ (1.0 mm).

In application, the flexible cover 10 is disposed on top of a container or cookware to be covered and the bottom surface of the flexible cover (shown in FIG. 2) lightly adheres to the top of a container or cookware, forming a seal. In that a single flexible cover 10 can be used on a plurality of different-sized containers or cookware, the flexible cover 10 can be thought of as a universal covering.

In some aspects, the flexible material 30 forms the entirety of the body of the flexible cover 10 such that the entire flexible cover 10 consists of the flexible material and differences in thickness of the flexible material form a plurality of regions 20 of increased rigidity. Thus, in some aspects, a flexible cover 10 for engaging and sealing an open-ended container includes a silicone rubber substrate having a web region 30 characterized by a first thickness and a first rigidity and a plurality of second regions 20 characterized a second thickness and a second rigidity, wherein the second thickness of the plurality of second regions is greater than the first thickness of the web region between the second regions. Alternatively, the flexible cover 10 for engaging and sealing an open-ended container includes a silicone rubber substrate having a web region 30 characterized by a first density of silicone rubber providing a first rigidity and a plurality of second regions 20 characterized a second density of silicone rubber providing a second rigidity, wherein the density of the plurality of second regions is greater than the first density of the web region between the second regions. In still another alternative embodiment, the flexible cover 10 for engaging and sealing an open-ended container includes a composite elastomer substrate having a web region 30 characterized by a first elastomer providing a first rigidity and a plurality of second regions 20 characterized a second elastomer providing a second rigidity, wherein the rigidity of the plurality of second regions is greater than the rigidity of the web region between the second regions.

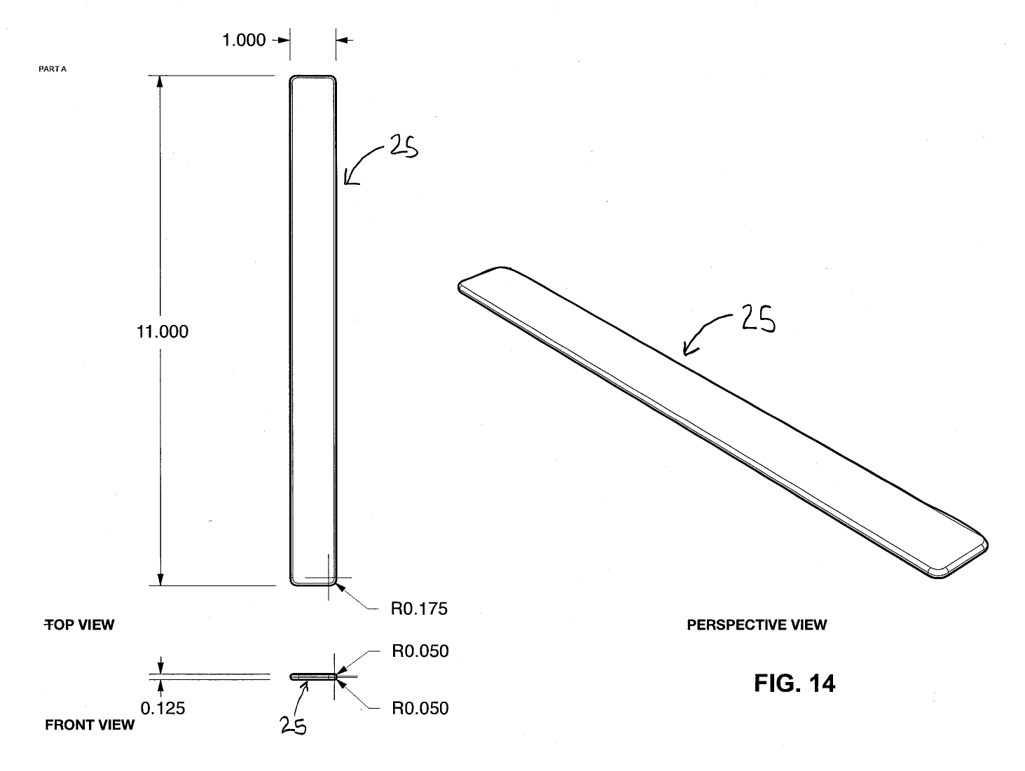

In at least some aspects of the present concepts, one or more of the regions 20 of increased rigidity comprise one or more inserts or slats 25 (see, e.g., FIGS. 14-20). In general, the slats may be uniform in one or more respects (e.g., slats of the same dimensions, shape and/or material) or may non-uniform in one or more of such respects. For example, a shape of the slats 25 may vary so that the regions 20 of increased rigidity are not necessarily uniform throughout the entirety of the flexible cover 10. Further, the slats 25 may utilize different cross-sectional profiles and/or different lengths and/or different materials in one region of the flexible cover 10 than in another region (e.g., so as to provide different characteristics in a center potion of the flexible cover than in a peripheral portion of the flexible cover). As another example, the slats 25 provided may alternate in size with alternating longer and shorter slats. In yet another example, the flexible cover 10 comprises three regions 20 of increased rigidity comprising a central region 20 of increased rigidity laterally larger (e.g., half of the flexible cover 10) than outer regions of increased rigidity (e.g., left and right regions of increased rigidity comprising about one quarter of the flexible cover 10).

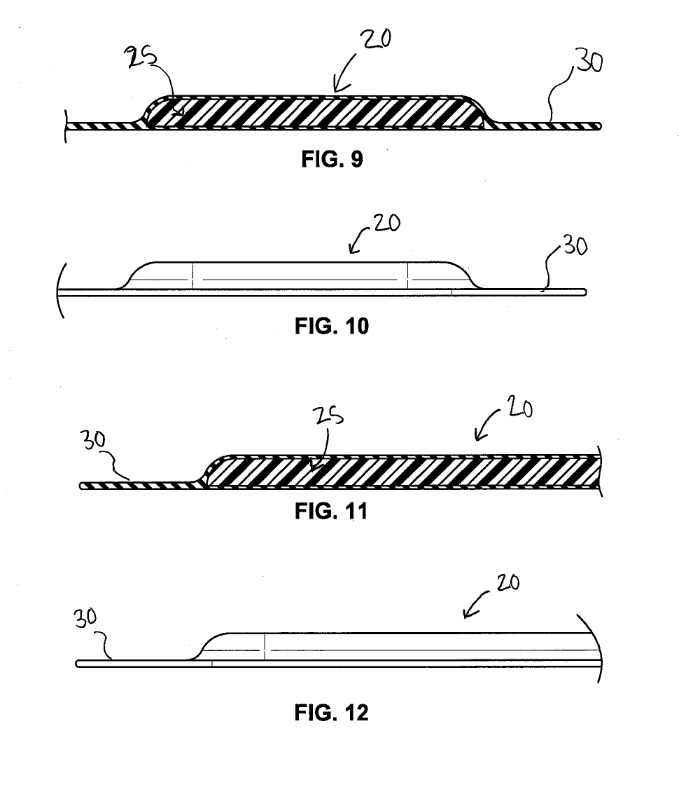

Further, although the exemplary figures provided herewith illustrate at least some aspects of the present concepts, the present concepts also include regions 20 of increased rigidity, either with or without inserts or slats 25, that present a profile other than a generally rectangular profile. For example, the regions 20 of increased rigidity could comprise a plurality of semi-circular or curvilinear regions (not shown).

Where provided, the inserts or slats 25 (see, e.g., FIGS. 14-20) comprise a semi-rigid or rigid material such as, but not limited to, rubber, plastic, aluminum, wood or a composite material, the material being selected for compatibility with the intended usage, having a rigidity greater than that of the flexible material forming the body of the flexible cover 10 (see FIGS. 9 and 11). Materials for the inserts may include, but are not limited to ABS, Acetal, High Density Polyethylene, Nylon, Polycarbonate, Polypropylene, Polystyrene, metals (e.g., Al, Ti, Stainless steel, etc.), selected for intended application (e.g., low temperature, high temperature, both low and high temperature, etc.). By way of example, the inserts may comprise Nylon 6-6 (also nylon 6,6) which provides high mechanical strength and rigidity with good stability under heat (up to about 250° C.). In other aspects, the inserts may comprise Nylon 6, a borosilicate glass (e.g., Pyrex, Schott Glass 8830, Corning 7740, SCHOTT BOROFLOAT® 33 etc.), or tempered soda-lime glass. The borosilicate glasses, for example, have very low coefficients of thermal expansion (˜3×10−6/° C. at 20° C.) and are highly resistant to thermal shock, which is advantageous in embodiments potentially subject to thermal stresses (e.g., cooking, contact with high temperature utensils or cookware, etc.). In yet other embodiments, the inserts may comprise a carbon fiber-reinforced carbon (e.g., a carbon fiber reinforcement in a graphite matrix), which is also well-suited to high temperature applications as it is highly resistant to thermal shock and has a low coefficient of thermal expansion. In yet other aspects, the inserts may comprise a ceramic (e.g., silicon carbide, alumina and boron carbide, etc.) or a glass-ceramic possessing a low or even negative coefficient of thermal expansion and high temperature stability (e.g., Schott CERAN®, Schott NEXTREMA™, etc.). The slat may comprise, in other aspects, a resin impregnated fabric (e.g., an epoxy resin forming a fiber reinforced plastic such as a fiberglass plain weave reinforced epoxy), or a thermosetting plastic.

Yet further, the flexible cover 10 may optionally comprise inserts of more than one material. For example, the flexible cover 10 may comprise one or more inserts formed from a borosilicate glass and one or more inserts formed from a carbon fiber-reinforced carbon. Such variability in insert selection may be functional (e.g., providing inserts having a greater rigidity on exterior lateral edges of the flexible cover 10) and/or aesthetic. Thus, depending on the desired application (e.g., required temperature ranges, etc.), desired aesthetics (e.g., colors, color combinations, etc.), and desired pricing, various different combinations of the above-noted materials can be provided.

Where slats 25 are utilized in the flexible cover, the elastomer forming the flexible cover 10 may have a thickness of about 0.02″ (0.5 mm) above, below and between the slats. In at least some other aspects, the elastomer forming the flexible cover 10 has a thickness of about 0.04″ (1.0 mm) on the top and bottom of the slats 25 and a thickness of about 0.06″ (1.5 mm) to 0.08″ (2.0 mm) in between the slats. The thickness between the slats, above the slats, and below the slats need not be uniform, but may rather be tailored for particular physical requirements (e.g., tensile strength, etc.) of a given application and characteristics of a selected slat material (e.g., coefficient of expansion over a range of indicated operating temperatures).

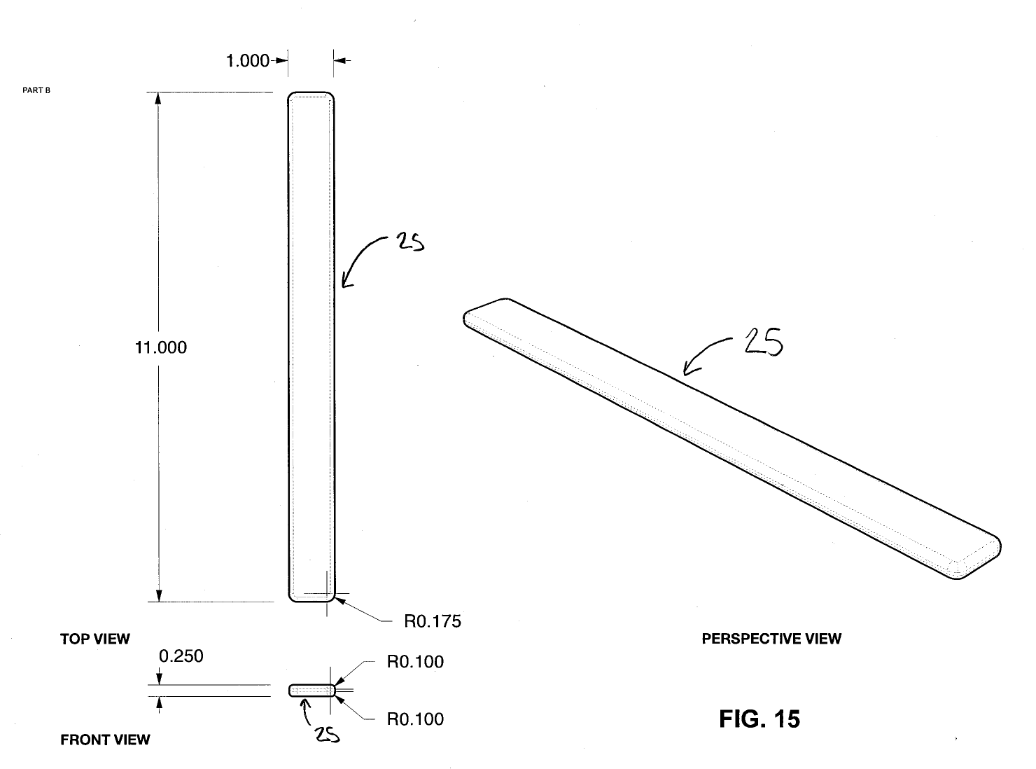

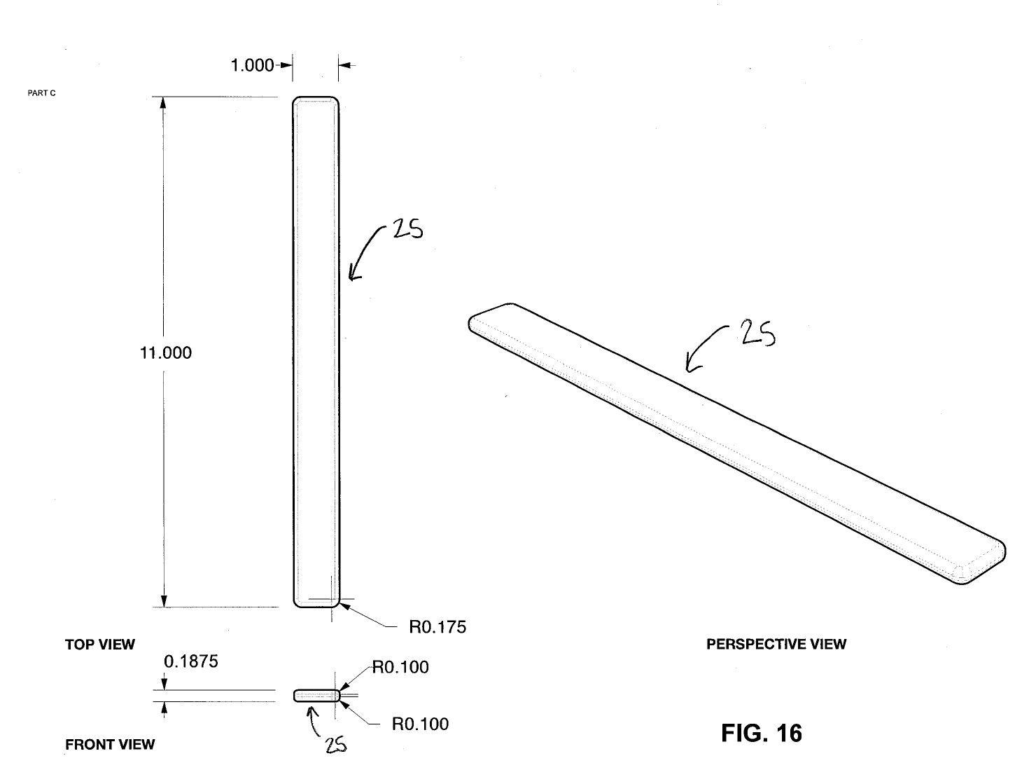

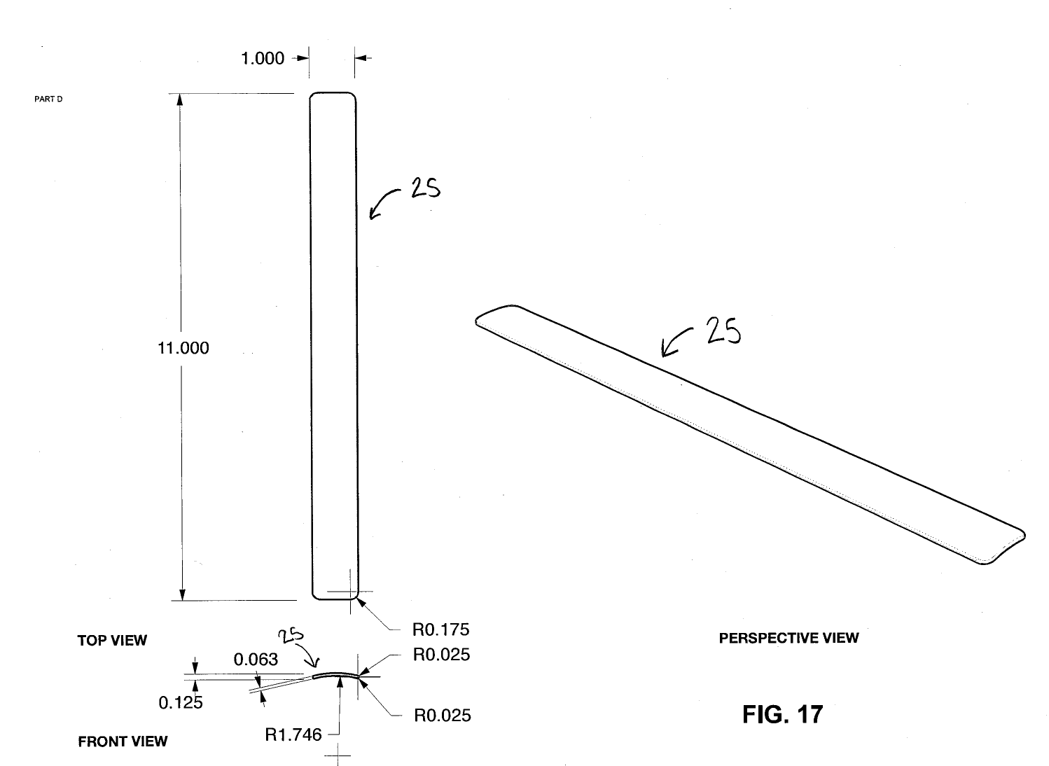

FIGS. 14-20 show a variety of different configurations of slats 25. These slats 25 may be formed from any material noted above (e.g., a nylon glass adapted to withstand repeated use at temperatures up to about 260° C.). In the embodiments depicted, the length of each of the depicted slats is 11.00″ long and 1″ wide, which correspond to the dimensions of the regions 20 of increased rigidity shown in the flexible cover 10 of FIGS. 1-13 (although the figures themselves are not necessarily to scale). In FIG. 14, the slat 25 is shown to be 0.125″ thick, whereas the slat in FIG. 15 is shown to be 0.250″ thick, and the slat in FIG. 16 is shown to be 0.1875″ thick. In each of these slats, the corners and edges are rounded to minimize the potential for degradation of (e.g., abrasion, cutting, etc.) the elastomer in which the slats are encapsulated. In FIG. 17, a curved slat 25 (e.g., having a curvilinear cross-sectional profile) is shown to be radiused at 1.746″, with a height of 0.125″ at the apex and a thickness of about 0.063″. In a similar embodiment, the curved slat 25 has a thickness of about 0.063,″ a height of 0.250″ at the apex, and is radiused at about 0.0825″.

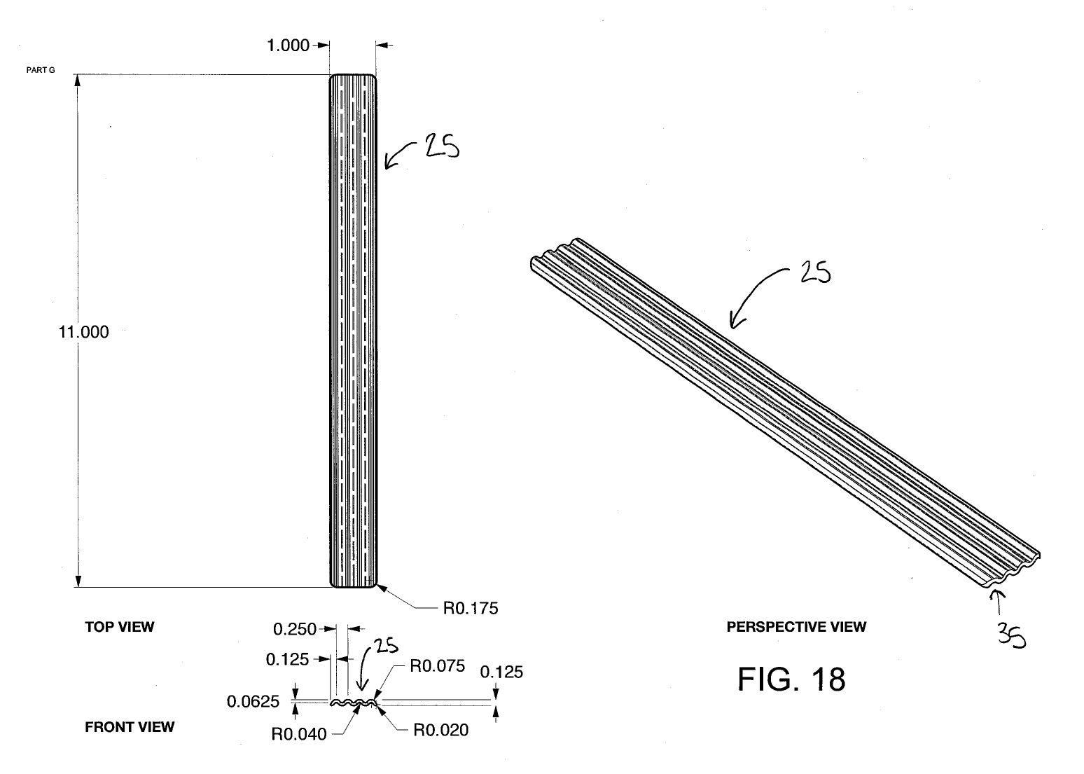

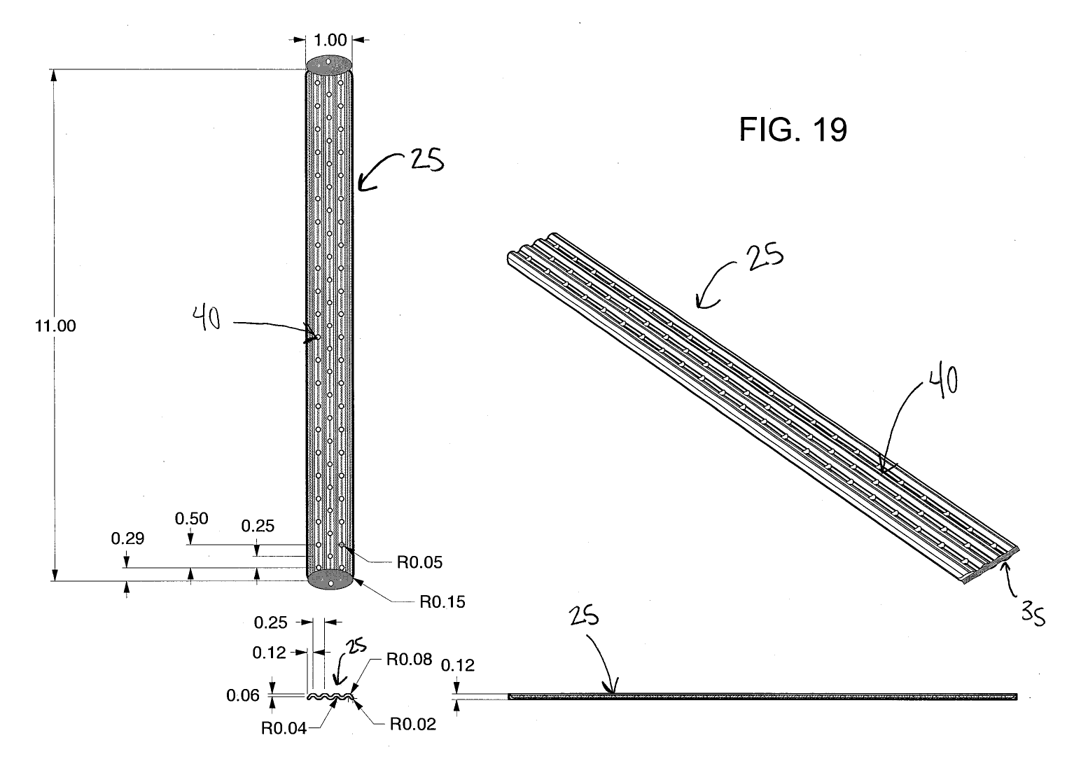

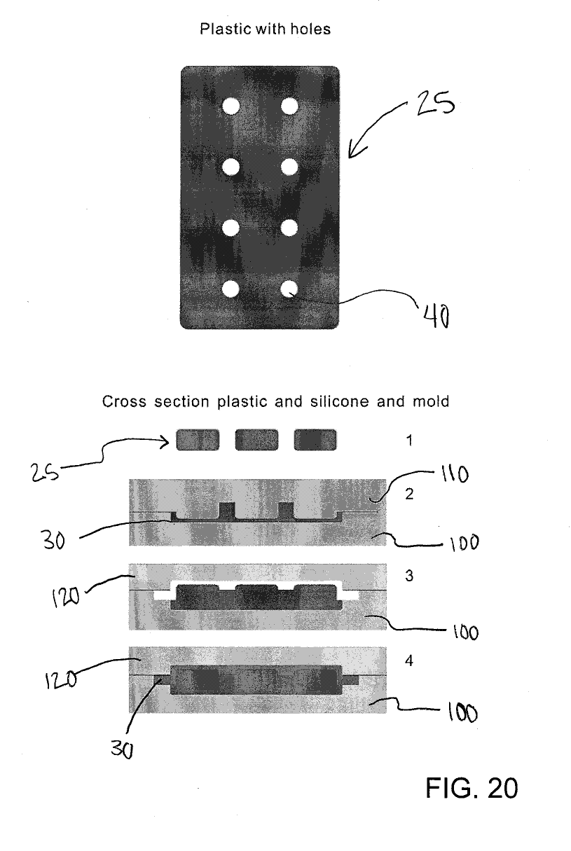

In yet another embodiment, the curved slat 25 has a thickness of about 0.125″, a height of 0.250″ at the apex, and is radiused at about 0.0825″. FIG. 18 shows yet another variant of slat 25, with a wavelike curvilinear cross-sectional profile defined by a plurality of cyclic paired crests and troughs 35. The crests are spaced apart by about 0.250″ with a distance from trough to crest of about 0.125″. A height of the slat 25 from crest to trough is about 0.125″. In a variant of slat 25 of FIG. 20, a wavelike curvilinear cross-sectional profile is defined by a plurality of cyclic paired crests and troughs 35, such crests being spaced apart by about 0.250″ with a distance from trough to crest of about 0.125″. In such variant, however, a height of the slat 25 from crest to trough is about 0.188″ and a thickness of the slat 25 is about 0.063″. FIG. 19 shows another variant of slat 25 of FIG. 20, with a wavelike curvilinear cross-sectional profile defined by a plurality of cyclic paired crests and troughs 35, such crests being spaced apart by about 0.250″ with a distance from trough to crest of about 0.12″. In FIG. 20, however, the slat 25 is formed with a plurality of through holes or openings 40. Although shown to be through holes of circular cross-section, the holes or openings 40 can be any shape (e.g., rectangular, oval, slots, etc.) and/or size, and or any combination of shapes and/or sizes. In various aspects of the present concepts, one or more through holes or openings 40 are advantageously formed in any of the slats 25 disclosed herein to provide enhanced bonding of elastomer on an upper portion of the flexible cover 10 with an elastomer on a bottom portion of the flexible cover.

Additionally, although an example of a rectangular flexible cover 10 is shown, the overall profile of the flexible cover 10 could alternatively be circular, square, oval, or other shape to accommodate different types of containers.

The flexible cover 10, described in accord with a variety of non-limiting exemplary embodiments herein, is thus adapted to provide a user with easy access to an interior volume of a variety of differently-dimensioned food containers or items of cookware (e.g., by lifting a side of the flexible cover 10 or by removing the flexible cover) on which the flexible cover is disposed.

Significantly, since the flexible cover 10 provides regions of enhanced rigidity, particularly those embodiments employing slats 25, multiple food service containers, food storage containers, food preparation containers, or items of cookware can be stacked on top of one another, with flexible covers 10 interspersed therebetween (e.g., disposed between each of the containers).

Yet further, the flexible cover's 10 flexibility, either with or without slats 25, allow the flexible cover 10 to collapse into a smaller size for storage and/or stacking For example, a flexible cover 10 with rectangular slats 25 can be rolled up along the lengthwise axis of the slats.

As can be readily understood, the elastomeric material of the flexible cover 10 provides a sufficiently high degree of friction and/or adhesion so as to help grip the food container to prevent the flexible cover from sliding off of the container during use or movement. Further, the material of the flexible cover 10 also offers light insulation for the contents of the food container, helping to keep contents at their original temperature for a longer duration than an open container.

Where the flexible cover is too large to practically be used on a container (e.g., the flexible cover of FIG. 13 is desired to be used on a square container that is 5″×5″, the flexible cover is readily able to be folded (e.g., folded in half) to accommodate the smaller container.

In other aspects, further to the regions 20 of higher rigidity rigid extending uniformly in a first direction, such as is shown in FIGS. 1-13, the regions 20 of higher rigidity may be presented along a plurality of different axes or directions. For example, regions 20 of higher rigidity (with or without inserts or slats 25) may be disposed along two different axes (e.g., crossing one another at an angle, orthogonal, etc.). For example, slats 25 may be provided along the longer length-wise direction of the flexible cover 10 at the outer edges to provide lateral rigid planes rotatable relative to the central portion of the cover and rotatable along axes orthogonal to the balance of the rigid planes extending in the first direction.

In still other aspects, the cover may be formed with one or more detachable sections to accommodate different end uses (e.g., sizes of containers to be covered). For example, embedded within the cover may be magnets (e.g., rare earth magnets, neodymium magnets, etc.) in mating joint portions of the cover. Other attachment means may also be employed including, but not limited to, snap-fit (male/female) connectors, tongue-in-groove connectors, or pin-in-slot connectors. These connectors may advantageously be provided at a location of, or integrated with, the aforementioned rigid planes and/or inserts.

A variety of methods of forming a flexible cover 10 may be utilized in accord with the present concepts and may include, but are not limited to, compression molding (an elastomer profile is placed directly in a heated mold, softened by the heat, and forced to conform to the shape of the mold as the press closes the mold) or injection molding (heated elastomer is injected into a closed cavity via a runner system, uncured elastomer is fed into the injection cylinder, preheated, metered and injected into the mold while controlling the pressure, injection time and temperature). The upper and lower portions of the flexible cover 10 could also be formed separately using other processes such as, but not limited to transfer molding, a combination of injection molding and compression molding and utilizing a compression press, and the upper and lower portions of the flexible cover 10 then being joined together in a separate forming step (or even using an adhesive, such as Dow Corning® 736 Heat Resistant/Sealant).

FIG. 20 shows, in accord with at least some aspects of the present concepts, shows one method of forming a flexible cover 10 (including slats 25), including a first act of injecting silicone rubber 30 into a first mold to form a lower portion of the flexible cover, the first mold comprising a first upper mold part 110 dimensioned to define lower surfaces of the flexible cover and a first lower mold part 100 dimensioned to define intermediary surfaces of the flexible cover, the lower surfaces of the flexible cover comprising a substantially planar bottom surface and the intermediary surfaces comprising a plurality of defined openings dimensioned to receive a plurality of slats. The method includes a second act of removing the first upper mold part 110 to provide access to the formed lower portion of the flexible cover and a third act of inserting a slat 25 in each of the openings defined by the upper surface of the lower portion of the flexible cover. The method further comprises a fourth act of disposing a second upper mold part 120 over the first lower mold part 100 to form a second mold, the second upper mold part 120 dimensioned to define upper surfaces of the flexible cover and a fifth act of injecting silicone rubber 30 into the second mold to form an upper portion of the flexible cover, the upper portion of the flexible cover being joined to the lower portion of the flexible cover so as to encapsulate the plurality of slats 25 disposed therein. The appropriate heating, cooling, and compression steps associated with each of the aforementioned steps are taken to be well known in the art for the particular working materials used to form the flexible cover 10.

Other methods of forming a flexible cover 10 (with or without slats 25) may include processing techniques other than compression molding or injection molding and/or other than the processing techniques noted above. By way of example, slats 25 can be positioned on top of silicone rubber supports in a first mold and the injection of silicone rubber is accomplished in a single act, rather than as a series of acts. The silicon rubber supports could alternatively extend through formed openings (e.g., openings 40 in the slat 25 of FIG. 19) and above the slats so as to contact both the upper and lower surfaces of the first mold to thereby enhance the positioning of and retention of the slat in an appropriate position during the injection of the silicone rubber.

Each of these embodiments and obvious variations thereof is contemplated as falling within the spirit and scope of the claimed invention, which is set forth in the following claims.

What is claimed is:

1. A flexible cover for engaging and sealing an open-ended container, the flexible cover comprising:
a silicone rubber substrate; and
a plurality of slats disposed within the silicone rubber substrate, the plurality of slats being spaced apart from one another.

2. The flexible cover according to claim 1, wherein at least some of the plurality of slats are disposed to be at least substantially parallel to one another.

3. The flexible cover according to claim 1, wherein each of the plurality of slats are disposed to be at least substantially parallel to adjacent slat or slats.

4. The flexible cover according to claim 1, wherein the silicone rubber substrate comprises a substantially planar bottom surface.

5. The flexible cover according to claim 1, wherein at least some of the plurality of slats have a substantially rectangular cross-section.

6. The flexible cover according to claim 1, wherein at least some of the plurality of slats have a curved cross-section.

7. The flexible cover according to claim 1, wherein at least some of the plurality of slats define, in cross-section, an undulating upper surface, an undulating lower surface, or both, along a lateral axis.

8. The flexible cover according to claim 1, wherein at least some of the plurality of slats define a plurality of through-holes.

9. The flexible cover according to claim 1, wherein at least one of the plurality of slats is selected from a material selected from the group consisting of rubber, plastic, thermosetting plastic, wood, composite material, ABS, Acetal, High Density Polyethylene, Nylon, Polycarbonate, Polypropylene, Polystyrene, titanium, stainless steel, aluminum, Nylon 6-6, Nylon 6, borosilicate glass, tempered soda-lime glass, carbon fiber-reinforced carbon, resin impregnated fabric, ceramic, or glass-ceramic.

10. The flexible cover according to claim 9, wherein a plurality of the plurality of slats comprise the same material.

11. The flexible cover according to claim 10, wherein a thickness of each of the plurality of slats is between about 0.125 inches and 0.250 inches.

12. The flexible cover according to claim 10, wherein a thickness of the silicone rubber between the plurality of slats is about 0.02 inches.

13. The flexible cover according to claim 10, wherein the plurality of slats are spaced apart from one another by a distance equal to about 0.5 times to 1.0 times a width of adjacent slats.

14. A method of forming a flexible cover for engaging and sealing an open-ended container, the flexible cover comprising a silicone rubber substrate and a plurality of slats disposed within the silicone rubber substrate, the plurality of slats being spaced apart from one another, the method comprising the acts of:
injecting silicone rubber into a first mold to form a lower portion of the flexible cover, the first mold comprising a first upper mold part dimensioned to define lower surfaces of the flexible cover and a first lower mold part dimensioned to define intermediary surfaces of the flexible cover, the lower surfaces of the flexible cover comprising a substantially planar bottom surface and the intermediary surfaces comprising a plurality of defined openings dimensioned to receive a plurality of slats;
removing the first upper mold part to provide access to the formed lower portion of the flexible cover;
inserting a slat in each of the openings defined by the upper surface of the lower portion of the flexible cover;
disposing a second upper mold part over the first lower mold part to form a second mold, the second upper mold part dimensioned to define upper surfaces of the flexible cover;
injecting silicone rubber into the second mold to form an upper portion of the flexible cover, the upper portion of the flexible cover being joined to the lower portion of the flexible cover so as to encapsulate the plurality of slats disposed therein.

15. The method of claim 14, wherein at least some of the plurality of slats have a substantially rectangular cross-section.

16. The method of claim 14, wherein at least some of the plurality of slats have a curved cross-section.

17. The method of claim 14, wherein at least some of the plurality of slats define, in cross-section, an undulating upper surface, an undulating lower surface, or both, along a lateral axis.

18. The method of claim 14, wherein at least some of the plurality of slats define a plurality of through-holes.

19. The method of claim 18, wherein, during the act of injecting silicone rubber into the second mold to form an upper portion of the flexible cover, the silicone rubber is caused to flow in the plurality of through-holes in the at least some of the plurality of slats to join together with the silicone rubber at the intermediary surfaces of the flexible cover.

20. A flexible cover for engaging and sealing an open-ended container, the flexible cover comprising:
a silicone rubber substrate having a web region characterized by a first thickness and a first rigidity and a plurality of second regions characterized a second thickness and a second rigidity;
wherein the second thickness of the plurality of second regions is greater than the first thickness of the web region.
